(19) United States
(12) Patent Application Publication
(10) Pub. No.: US 2025/0262955 A1
(43) Pub. Date: Aug. 21, 2025

(54) INCREASING THE OPERATING TIME OF A ROAD CONSTRUCTION MACHINE

(71) Applicant: JOSEPH VÖGELE AG, Ludwigshafen (DE)

(72) Inventor: Klaus ÖTTINGER, Altlußheim (DE)

(73) Assignee: JOSEPH VÖGELE AG, Ludwigshafen (DE)

(21) Appl. No.: 19/059,805

(22) Filed: Feb. 21, 2025

(30) Foreign Application Priority Data
Feb. 21, 2024 (EP) 24158795.5

(51) Int. Cl. B60L 50/60; B60K 6/28; B60K 15/03; B60L 50/75; B60L 58/18; B62D 65/02; E01C 19/48

(52) U.S. Cl. CPC B60L 50/60; B60K 6/28; B60K 15/03; B60L 50/75; B60L 58/18; B62D 65/02; B60L 2200/40; B60Y 2200/92; E01C 19/48; E01C 2301/04

(57) ABSTRACT

A road construction machine includes a chassis for moving the road construction machine, a primary drive for driving the chassis, a primary storage unit for supplying the primary drive with electrical energy or an energy medium, a material hopper and a material hopper insert for receiving paving material. The material hopper insert is detachably mounted on the material hopper. The material hopper insert has at least one secondary storage unit for driving the chassis and/or for supplying the primary drive with electrical energy or the energy medium.

### CROSS-REFERENCE TO RELATED APPLICATIONS

This application claims foreign priority benefits under 35 U.S.C. § 119(a)-(d) to European patent application number EP 24158795.5 filed Feb. 21, 2024, which is incorporated by reference in its entirety.

### TECHNICAL FIELD

The present disclosure relates to a road construction machine comprising a material hopper insert with a secondary storage unit, a method of replacing a material hopper insert with a secondary storage unit on a road construction machine, and a method for operating a road construction machine.

### BACKGROUND

Road construction machines are generally known from the prior art. These can be, for example, a road paver for producing a paving layer from a paving material or a feeder vehicle for supplying the road paver with the paving material.

Conventional road construction machines usually use diesel fuel as an energy source. The chemical energy of the diesel fuel is converted into mechanical energy via a diesel engine, which is used to operate actuators. The actuators usually perform rotary movements or translatory movements. The road construction machine then uses these movements to carry out its work and subtasks. For a road paver, this would be, for example, driving, steering, conveying material, distributing material, levelling, compacting material. For a feeder vehicle, this would be, for example, driving, steering, conveying material. Rotational movements are implemented with the help of hydraulic motors, for example, and translational movements with hydraulic cylinders, for example. For the screed heating of a road paver, mechanical energy is converted into electrical energy via a generator, which is then converted into heat. The disadvantage of this drive mechanism is the use of fossil fuels (e.g., diesel fuel) and the associated exhaust emissions.

It is also known from the state of the art that road construction machines can be driven electrically. With electrified road construction machines, however, the shorter range of the road construction machine is problematic. Current road construction machines with diesel tanks are designed in such a way that they can usually be driven for a maximum of 10 hours on one tank of fuel and can therefore achieve a certain range. This assumes a high utilization of the road construction machine. When using an energy storage device for an electrified road construction machine, such as a battery, for example an accumulator, as an energy source and electric drive trains, significantly larger and heavier energy storage devices would have to be used to achieve similar ranges, due to the lower energy density of an accumulator compared to the energy density of diesel fuel. As this can only be achieved to a limited extent without drastically increasing the size of the road construction machine, the result is a significant reduction in the working time or amount of work that an electrically powered road construction machine can perform. Due to the shorter range of an electrified road construction machine with a battery as an energy source, the battery would have to be replaced or recharged one or more times. Alternatively, the road construction machine with the empty battery would have to be driven away from the construction site so that another road construction machine with a charged battery can be used as a replacement. Consequently, the construction site would have to be interrupted for a short or longer period of time. Interrupting the construction site is not only detrimental to the energy efficiency of the road construction machine (e.g., the screed and the material conveyors have to be warmed up again after the interruption), but also to the paving quality. This is because interruptions potentially lead to start-up marks, segregation, a drop in the temperature of the mix, compaction problems and even cooling and solidification of the paving material in the road construction machine.

### SUMMARY

Based on the known state of the art, an objective technical problem to be solved is to provide a road construction machine that eliminates or at least reduces the above-mentioned disadvantages. Ideally, the range or service life of the road construction machine should be increased.

This task may be solved by a road construction machine according to the disclosure, a method according to the disclosure for replacing a material hopper insert with a secondary storage unit on a road construction machine or a method for operating a road construction machine according to the disclosure.

According to one aspect of the disclosure, a road construction machine is provided. The road construction machine comprises a chassis for moving the road construction machine, a primary drive for driving the chassis, a primary storage unit for supplying the primary drive with electrical energy or an energy medium, a material hopper and a material hopper insert for receiving paving material. The material hopper insert is detachably mounted on the material hopper. The material hopper insert has at least one secondary storage unit for driving the chassis and/or for supplying the primary drive with electrical energy or the energy medium. This can extend the operating time and range of the road construction machine, especially the self-propelled one. It is possible to avoid stopping a road construction operation, in particular the production of a paving layer from the paving material, if the road construction machine runs out of energy or energy medium. Ideally, this can improve the paving quality of the paving layer or at least ensure an almost constant paving quality during the production of the paving layer. Since paving units of the road construction machine, such as screed and material conveyor, have to be warmed up again after an interruption, embodiments according to the disclosure can optionally increase the energy efficiency of the road construction machine.

The chassis can be a chassis with wheels or a crawler chassis. The chassis with wheels can comprise several driven wheels by means of which the road construction machine can be moved. The crawler chassis can comprise at least one driven crawler by means of which the road construction machine can be moved.

The primary drive for driving the chassis can be mounted at any point on the road construction machine, preferably in the vicinity of the chassis, in particular in a detachable manner. The primary drive can be designed to drive the chassis in such a way that the chassis moves the road construction machine in one direction of travel. To drive the chassis, the primary drive and the chassis can be mechanically connected to each other.

The primary storage unit can be mounted, preferably detachably, at any position on the road construction machine, preferably in the vicinity of the primary drive, in particular detachably. The primary storage unit may be suitable for storing electrical energy or an energy medium. The primary storage unit can be mechanically and/or electrically connected to the primary drive in order to supply the primary drive with electrical energy or the energy medium. The primary storage unit can be a battery, in particular a rechargeable battery, for example an accumulator (battery). Optionally, the primary storage unit can be a tank for storing the energy medium, for example fossil or fossil-free fuel.

The chassis, the primary drive, a secondary drive described below, the primary storage unit and/or the secondary storage unit can be communicatively connected.

The road construction machine can comprise a control system. The control system may be communicatively connected to the chassis, the primary drive, the secondary drive, the primary storage unit and/or the secondary storage unit. The control system may be configured to control and monitor a drive and a movement of the road construction machine. For example, the control system may be configured to monitor a charge state or fill level of the primary storage unit and/or the secondary storage unit of the road construction machine. The control system may further be configured to control and monitor a transfer of electrical energy or the energy medium from the primary storage unit and/or the secondary storage unit to the primary drive and/or the secondary drive of the road construction machine to drive the road construction machine.

The material hopper insert can be detachably mounted to the material hopper by means of a fastening device. The fastening device can be a screwing or clamping device, for example. This can make it easy to attach, detach and replace the material hopper insert, for example for maintenance or cleaning purposes. In particular, this can make it particularly easy to replace the secondary storage unit, for example to replace an empty secondary storage unit with a filled secondary storage unit. Optionally, transportation of the material hopper insert, for example by truck, can be facilitated, as the material hopper insert can be transported separately from the material hopper.

Preferably, the primary drive is an electric motor, in particular with a fuel cell, or a combustion engine. The primary drive can depend on the type, location and/or duration of use of the road construction machine. With an electric motor, in particular with a fuel cell, the road construction machine can be operated without directly emitting pollutants. Ideally, the road construction machine can be operated with low noise levels. This can be particularly advantageous if the road construction machine is only to emit a limited amount of noise or pollutants, for example if it is to be operated in or near a built-up area. Compared to a road construction machine powered by an electric motor, a combustion engine can enable the road construction machine to be operated relatively economically over a long range. This can be particularly advantageous if there are no requirements for noise or pollutant limits or if the road construction machine is to be operated over long distances without interruption.

The secondary storage unit can be mounted, preferably detachably, at any point on the material hopper insert. The secondary storage unit can be mechanically and/or electrically connected to the primary drive in order to supply the primary drive with electrical energy or energy media.

Preferably, the secondary storage unit comprises an additional battery, in particular with a battery management system, for storing electrical energy for the primary drive. This allows the primary drive, in particular the electric motor, to be easily supplied with electrical energy. In particular, the additional battery can be rechargeable. For example, the battery can be an additional accumulator. The additional battery can be electrically connected to the primary drive in order to supply the primary drive with electrical energy. Optionally, the additional battery can be electrically connected to the secondary drive in order to supply the secondary drive with electrical energy.

Preferably, the secondary storage unit comprises an additional tank for storing energy medium, in particular in liquid or gaseous form, for the primary drive. The additional tank can be mechanically connected to the primary drive in order to supply the primary drive with the energy medium. Optionally, the additional tank can be mechanically connected to the secondary drive in order to supply the secondary drive with the energy medium.

Preferably, the energy medium is hydrogen and/or ammonia and/or fossil fuel and/or a synthetic fuel. This allows the road construction machine to be supplied with conventional energy medium at low cost. The energy medium may depend on the type of primary drive and/or secondary drive.

Preferably, the additional tank is designed for compressed hydrogen storage or storage of chemically bound hydrogen, in particular bound by means of LOHC or ammonia. Optionally, the secondary storage unit can comprise an electrolyzer for releasing hydrogen bound, in particular as LOHC or ammonia.

Preferably, the secondary storage unit has a secondary drive for driving the chassis of the road construction machine. This allows the road construction machine to be operated either with the primary drive and/or with the secondary drive. That is, the chassis can be driven by at least one of the secondary drive and the primary drive. The secondary drive can, for example, be an electric motor or a combustion engine, in particular with a generator for converting mechanical energy into electrical energy. The secondary drive can be mounted at any point on the secondary storage unit. By providing a secondary drive in addition to the primary drive, the reliability of the road construction machine can be increased. For example, the secondary drive can drive the chassis of the road construction machine if operation by means of the primary drive is not possible, for example if the primary drive is defective. Optionally, the secondary drive can drive the chassis in addition to the primary drive, for example if the drive force of the primary drive is not sufficient to move the road construction machine. This enables reliable operation of the road construction machine. Optionally, the secondary drive can be electrically connected to the primary storage unit. For example, the secondary drive can be a combustion engine with a generator and the secondary storage unit can be an energy storage tank. The combustion engine generates mechanical energy using the energy provided by the secondary storage unit. The generator converts the mechanical energy into electrical energy and forwards it to the primary storage unit in the form of a rechargeable battery, which then supplies the road construction machine with electrical energy.

Preferably, the material hopper insert has a base opening and a plurality of side walls adjacent thereto, wherein at least one side wall is inclined with respect to the base opening, in particular a base opening surface, such that an upper edge of the inclined side wall, in particular in a plan view, lies outside the base opening, in particular the base opening surface, wherein the secondary storage unit is arranged below the inclined side wall. The side wall can comprise a bottom edge, in particular opposite the top edge. The base opening, in particular the base opening area, can be formed by the lower edges of the side walls. An upper opening surface can be spanned between the upper edges. The material hopper insert can, for example, be funnel-shaped, in particular in such a way that the upper opening area is larger than the bottom opening area. This can enable the material hopper insert to be filled easily and evenly with paving material. By arranging the secondary storage unit below the inclined side wall, it is possible to use an existing installation space in the material hopper. A very compact design of the road construction machine can be realized. The upper edge of the inclined side wall can extend parallel to a longitudinal extension of the road construction machine, in particular in the direction of travel, especially when viewed from above. The inclined side wall can, for example, be a lateral side wall of the material hopper insert. The secondary storage unit can be arranged below the lateral side wall. Optionally, the upper edge of the inclined side wall can extend orthogonally to the longitudinal extension of the road construction machine, in particular in the direction of travel, especially when viewed from above. The inclined side wall can, for example, be a front wall or a rear wall of the material hopper insert. The secondary storage unit can be arranged below the front wall or the rear wall.

Preferably, an angle between the side wall and a plane of the base opening, in particular the base opening surface, is at least 100°, preferably at least 110°, and/or at most 135°, preferably at most 125°. In principle, the angle can be of any suitable size. The size of the angle can depend on the material hopper, the material hopper insert and/or the secondary storage unit. The angle size can be selected in such a way that the paving material in the material hopper insert can slide easily and, in particular, evenly onto a conveyor unit of the road construction machine arranged below the material hopper insert.

Preferably, the inclined side wall forms a cover for the secondary storage unit, especially in the top view of the main bunker insert. This allows the secondary storage unit to be protected from external influences, in particular damage. This can increase the service life of the secondary storage unit and ideally reduce repair/maintenance costs. The inclined side wall can at least partially, preferably completely, cover the secondary storage unit, especially when viewed from above.

Preferably, the material hopper insert has thermal insulation. This prevents the temperature of the paving material in the material hopper insert from changing significantly, in particular from cooling down. Ideally, it can be ensured that the paving material in the material hopper insert has a minimum temperature, for example at least around 80° C. This can improve further processing of the paving material. Ideally, it is possible to prevent the paving material from solidifying in the material hopper insert. The warm paving material can release some of its heat to the material hopper insert and heat it up. The thermal insulation can be used to reduce the heat emitted by the material hopper insert to its surroundings and in particular to the secondary storage unit. This can ensure that the secondary storage unit is not heated too much by the heat emitted by the material hopper insert and, in the worst case, becomes too warm for operation. In particular, a thermal management system of the secondary storage unit, which controls its temperature for operation, can be dimensioned smaller, in particular with less power. Optionally, a heating device for heating a paving screed and/or a conveyor belt can be dimensioned smaller, in particular with less power, due to the thermal insulation. If the paving material does not fall below a minimum temperature, it can be achieved that the heating device has to use less energy to keep the paving material warm for further processing. The thermal insulation can be attached at least in sections or completely to the material hopper insert, in particular on an outer side of its side walls. The thermal insulation can, for example, be an insulating mat or insulting foil that can be attached, in particular detachably, to the material hopper insert. Optionally, the thermal insulation can be sprayed or sprayed onto the material hopper insert as an insulating film, in particular non-detachably.

The material hopper insert can comprise at least one picking device for lifting the material hopper insert into and/or out of the material hopper. This can enable easy assembly and disassembly of the material hopper insert on the material hopper. Ideally, this can enable the material hopper insert to be changed quickly and easily, for example for maintenance or cleaning purposes. For example, the picking device can be designed as an eyelet into which a lifting device, for example a crane hook, can engage to move the material hopper insert.

Preferably, the secondary storage unit can be connected to the road construction machine, in particular the primary drive and/or the primary storage unit, via an interface for transmitting electrical energy or the energy medium. This can enable simple transmission of electrical energy or the energy medium. Via the interface, the road construction machine can dock to the secondary storage unit or vice versa. Via the interface, the secondary storage unit can be mechanically or electrically connected to the road construction machine. If energy medium is transferred, the interface can, for example, comprise one connection opening, e.g. tank opening, on the road construction machine and one on the secondary storage unit, which can be connected to each other via a hose (mechanical connection). The hose can be disconnected or removed from the road construction machine and/or the secondary storage unit in order to exchange the secondary storage unit. If energy is transmitted, the interface can, for example, comprise a plug socket on the road construction machine and a plug socket on the secondary storage unit, which can be connected via a cable (electrical connection). The cable can be inserted into the respective plug socket via a plug or held on the plug socket via a magnet, for example, in order to establish an electrical connection between the road construction machine and the secondary storage unit. The cable can be disconnected from the road construction machine and/or the secondary storage unit in order to exchange the secondary storage unit.”

Preferably, the road construction machine is a road paver for producing a paving layer from the paving material or a feeder vehicle for supplying the road paver with the paving material. This can extend the operating time and range of the road paver or the feeder vehicle. It can be avoided that the road paver or the feeder vehicle has to be stopped before the paving layer is completed and thus the paving process has to be interrupted. In particular, this can improve the paving quality of the paving layer or at least ensure an almost constant paving quality during the production of the paving layer.

The primary drive and/or the secondary storage unit can supply at least one, in particular electrical, consumer of the road construction machine with, in particular electrical, energy. This allows the chassis and the consumers of the road construction machine to be driven together. There is no need for a separate drive or energy storage unit for the consumers. This can contribute to a particularly compact and lightweight design of the road construction machine. In principle, the consumer can be any consumer required for the use of the road construction machine. On the road paver, the consumer can be, for example, an electrically operated lighting system, an electrically operated heating device, an electrically operated electro-hydraulic unit, an electrically operated longitudinal conveyor device and/or an electrically operated transverse conveyor device. The consumer on the feeder vehicle can be, for example, an electrically operated lighting system, an electrically operated conveyor device for built-in material and/or an electrically operated heating device of the feeder vehicle. The primary drive and/or the secondary storage unit can be connected to only one or to several consumers. Optionally, the consumer may be connected to at least one of the primary drive and the secondary storage unit.

According to a further aspect of the disclosure, a method for replacing a material hopper insert with a secondary storage unit on a road construction machine is provided. The method comprises the steps of: releasing a first fastening device of a first material hopper insert from a material hopper of the road construction machine; removing the first material hopper insert with a first secondary storage unit from the material hopper; inserting a second material hopper insert with a second secondary storage unit into the material hopper; and fastening the second material hopper insert to the material hopper by means of a second fastening device. The first material hopper insert and the second material hopper insert can be of identical or different design. The first secondary storage unit and the second secondary storage unit can be of identical or different design.

Preferably, electrical energy or an energy medium can be transmitted between the secondary storage unit and the road construction machine via an interface, wherein a connection between the first secondary storage unit and the road construction machine is released via a first interface before the first material hopper insert is removed from the material hopper and/or wherein a connection between the second secondary storage unit and the road construction machine is established via a second interface after the second material hopper insert has been attached to the material hopper.

According to a further aspect of the disclosure, a method for operating a road construction machine is provided. The method comprises the steps of: providing electrical energy or an energy medium via a primary storage unit of the road construction machine; supplying a primary drive of the road construction machine with electrical energy or the energy medium via the primary storage unit; driving a chassis of the road construction machine via the primary drive; and moving the road construction machine via the chassis. At least one secondary storage unit supplies the primary drive with electrical energy or energy medium and/or drives the chassis, wherein the secondary storage unit is mounted on a material hopper insert for receiving paving material. The material hopper insert is detachably mounted on a material hopper of the road construction machine.

The secondary storage unit can supply the primary drive with electrical energy or the energy medium when the supply of electrical energy or the energy medium to the primary drive by the primary storage unit has ended. If, for example, a state of charge of the primary storage unit is not sufficient for the production of an installation layer, the secondary storage unit can supply the primary drive with energy or the energy medium instead of the primary storage unit when the primary storage unit reaches a minimum state of charge.

The secondary storage unit, in particular a secondary drive of the secondary storage unit, can drive the chassis when a drive of the chassis by the primary drive has ended. For example, the secondary drive can drive the chassis of the road construction machine if operation by means of the primary drive is not possible, for example if the primary drive is defect. For example, a control system of the road construction machine can monitor the operation of the primary drive and cause the secondary drive to drive the chassis if operation by means of the primary drive is not possible. Optionally, an operator of the road construction machine can manually stop the operation of the primary drive and initiate the operation of the secondary drive.

The features or explanations described for one of the aspects of the disclosure (road construction machine or method) can be transferred individually or in combination to the other aspects and combined with them.

### BRIEF DESCRIPTION OF THE DRAWINGS

In the following, embodiments according to the disclosure are explained with reference to the following drawings:

FIG. 1 a perspective view of a road construction machine in the form of a road paver according to an embodiment;

FIG. 2 a perspective view of a material hopper insert for the road paver according to an embodiment;

FIG. 3 a schematic front view of the road paver from the front;

FIG. 4 a schematic view of the road paver from above;

FIG. 5 a perspective view of a road construction machine in the form of a feeder vehicle according to an embodiment; and

FIG. 6 a perspective view of the material hopper insert for the feeder vehicle according to an embodiment.

### DETAILED DESCRIPTION

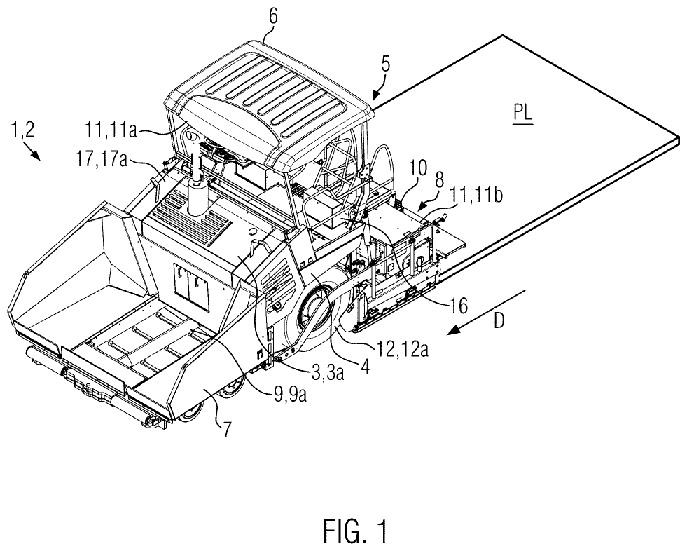

FIG. 1 shows a perspective view of a road construction machine 1 in the form of a road paver 2 according to an embodiment. The road paver 2 is configured to produce a paving layer PL from paving material PM (asphalt mix) (see FIG. 4). The road paver 2 is self-propelled in a direction of travel D.

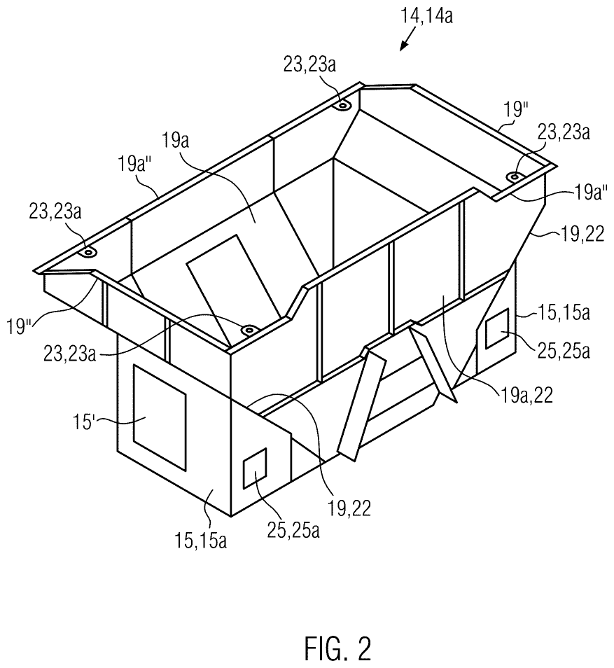

The road paver 2 also has a chassis 4, an operator's platform 5 for an operator of the road paver 2, a driver's roof 6 and a material hopper 7. A material hopper insert 14 for holding the paving material PM is mounted on the material hopper 7 (see FIGS. 2 to 4). Furthermore, a height-adjustably mounted paving screed 8, which is towed in the direction of travel D, and a conveyor unit 9 comprising a conveyor belt 9a are attached to the chassis 4 in order to provide the paving material PM from the material hopper insert 14 of the road paver 2 to the paving screed 8 by means of a cross-distribution device 10 of the road construction machine 1.

FIG. 1 also shows two exemplary electrical consumers 11 of the road paver 2. A first electrical consumer 11a is a lighting device for illuminating the surroundings or the control stand 5. A second electrical consumer 11b is a heating device for heating the paving screed 8. The paving screed 8 comprises components such as compaction aggregates (screed plates, tamper and pressure bars (not shown). The paving material PM is compacted by the action of the compaction unit's own weight. To prevent the paving material PM from sticking to the components of the paving screed 8, heating devices (not shown), usually electric heating devices, can be integrated into these components.

In order to move in the direction D, the road paver 2 has a wheeled chassis 12 with two driven wheels 12a. The road paver 2 also has a primary drive 3 in the form of an electric motor 3a to drive the wheeled chassis 12. With the electric motor 3a, the road paver 2 can be operated without directly emitting pollutants. Ideally, the road paver 2 can be operated with low noise levels. This is particularly advantageous if the road paver 2 is only allowed to emit a limited amount of noise or pollutants, for example if it is to be operated in or near a built-up area. The electric motor 3a is designed to drive the wheeled chassis 12 in such a way that the wheeled chassis 12 moves the road paver 2 in the direction of travel D. For this purpose, the electric motor 3a and the wheeled chassis 12 are mechanically connected to each other.

Further, the electric motor 3a is electrically connected to a primary storage unit 17 in order to be supplied with electrical energy by the latter. For this purpose, the primary storage unit 17 is designed as a rechargeable accumulator 17a in order to store electrical energy and deliver it to the electric motor 3a. The accumulator 17a is detachably mounted on the road paver 2 in the vicinity of the electric motor 3a by means of a screw connection.

FIGS. 2 to 4 show details of the material hopper insert 14. The material hopper insert 14 is used to store the paving material PM and is detachably mounted on the material hopper 7. For this purpose, for example, four fastening devices 24 are provided in the form of screw connections, which are arranged on the outer sides of side walls 19a of the material hopper insert 14 and connect the material hopper insert 14 to the material hopper 7 (see FIG. 4). This makes it easy to replace the material hopper insert 14, for example for maintenance or cleaning purposes.

As FIG. 2 shows, the material hopper insert 14 also has thermal insulation 22. This is completely glued to the outer sides of all side walls 19, 19a of the material hopper insert 14 in the form of an insulating film. This prevents the temperature of the paving material PM in the material hopper insert 14 from changing significantly, in particular from cooling down and solidifying in the material hopper insert 14.

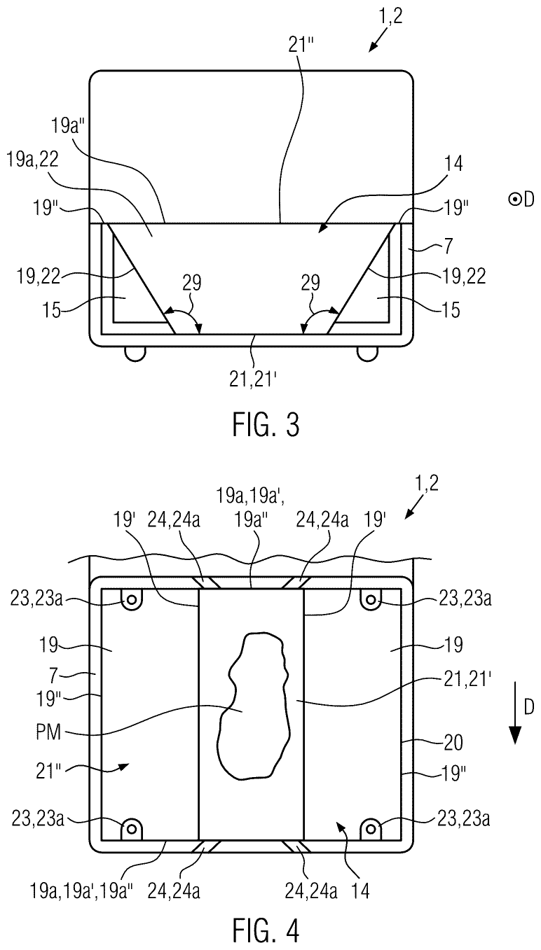

FIGS. 3 and 4 show a schematic front view and top view of the road paver 2, in particular of the material hopper insert 14. The material hopper insert 14 has a bottom opening 21. The paving material PM located in the material hopper insert 14 falls through the bottom opening 21 onto the conveyor belt 9a and is passed on by this to the paving screed 8.

The bottom opening 21, in particular a bottom opening surface 21′, is formed by the four side walls 19, 19a, in particular their lower edges 19′, 19a′. The side walls 19, 19a also have upper edges 19″, 19a″, which lie opposite the lower edges 19′, 19a′ and span an upper opening surface 21″. The upper opening surface 21″ is larger than the bottom opening surface 21′, particularly when viewed from above. The opposing side walls 19 are inclined with respect to the bottom opening 21 such that their upper edges 19″ lie outside the bottom opening 21 in the plan view of the material hopper insert 14. An angle 29 between the side wall 19 and a plane of the base opening 21, in particular the base opening surface 21′, is approximately 130°. Thus, the material hopper insert 14 is funnel-shaped. This enables the material hopper insert 14 to be filled easily and evenly with paving material PM.

In order to increase the range and operating time of the road paver 2, the road paver 2 also has one or two secondary storage units 15, which have essentially the same structure (see FIG. 2). The secondary storage units 15 each comprise an additional accumulator 15′ for storing electrical energy. The secondary storage units 15 are each electrically connected to the electric motor 3a via an interface 25 in order to transmit the electrical energy to the electric motor 3a. This makes it possible for the electric motor 3a to be supplied with electrical energy via the secondary storage units 15 in addition to or as an alternative to the supply via the primary storage unit 17. This increases the reliability of the road paver 2. If, for example, the charge state of the primary storage unit 17 is not sufficient for the production of a paving layer PL, it is possible to supply the electric motor 3a with energy via the secondary storage units 15. This prevents the road paver 2 from having to be stopped before the paving layer PL is completed, thereby interrupting the paving process. This improves the paving quality of the paving layer PL in particular.

The secondary storage units 15 are detachably mounted on the outer sides of the inclined side walls 19 of the material hopper insert 14, in particular on the thermal insulation 22, by means of a screw connection. This means that the secondary storage units 15 are each arranged below the inclined side walls 19. This makes use of the available installation space and enables a particularly compact design of the road paver 2.

In the top view of the material hopper insert 14, the inclined side walls 19 also form a cover for the secondary storage units 15 (see FIGS. 3 and 4). The inclined side walls 19 completely cover the secondary storage units 15. This protects the secondary storage units 15 from external influences, in particular damage. This increases the service life of the secondary storage unit 15 and ideally reduces repair/maintenance costs.

Furthermore, the primary storage unit 17 and the secondary storage unit(s) 15 are each electrically connected to the electrical loads 11 in order to supply them with energy. This means that no separate energy storage unit is required for the loads 11. This contributes to a compact and lightweight design.

The road paver 2 is controlled via a control system 16 (see FIG. 1). The control system 16, the wheeled chassis 12, the electric motor 3a, the primary storage unit 17, the secondary storage unit(s) 15 and the consumers 11 are communicatively connected to each other. The control system 16 monitors the energy requirements of the road paver 2. Furthermore, the control system 16 monitors the charge status of the primary storage unit 17 and the secondary storage unit(s) 15. If the control system 16 detects, for example, that the charge status of the primary storage unit 17 is not sufficient for the production of the paving layer PL, it causes the electric motor 3a to be additionally supplied with energy via the secondary storage unit or units 15. This prevents the road paver 2 from having to be stopped before the paving layer PL is completed, thereby interrupting the paving process.

Further, FIGS. 2 to 4 show the road paver 2 before and after the first material hopper insert 14 mounted on the road paver 2 has been replaced by a second material hopper insert 14a. The first material hopper insert 14 and the second material hopper insert 14a are essentially identical in construction. Likewise, the first secondary storage unit 15 and the second secondary storage unit 15a are essentially identical in construction. To replace the first material hopper insert 14, the first secondary storage units 15 are first disconnected from the road paver 2 via the first interfaces 25. In the next step, the first fastening devices 24 of the first material hopper insert 14 are manually detached from the material hopper 7. This has the advantage that no additional tools are required. In the next step, the first material hopper insert 14 (and thus the first secondary storage unit(s) 15) is removed from the material hopper 7. In order to lift the material hopper insert 14, four picking devices 23 in the form of eyelets are attached to the two side walls 19a. A lifting device, for example a hook of a crane, engages in the eyelets and thus lifts the material hopper insert 14 out of the material hopper 7. This makes it easy to remove the material hopper insert 14 from the material hopper 7. In the next step, a second material hopper insert 14a is inserted into the material hopper 7. This is carried out in the same way as the removal of the first material hopper insert 14 by means of the crane, which engages with the second material hopper insert 14a at four picking devices 23a. One or two second secondary storage units 15a are mounted on the second material hopper insert 14a, so that the second secondary storage unit or units 15a are placed in the material hopper 7 together with the second material hopper insert 14a. In the next step, the second material hopper insert 14a is fastened to the material hopper 7 by means of four second fastening devices 24a. In the next step, the second secondary storage units 15a are connected to the road paver 2 via second interfaces 25a. The second secondary storage units 15a are thereby mechanically connected to the electric motor 3a in order to transmit electrical energy to the electric motor 3a and thereby drive the road paver 2.

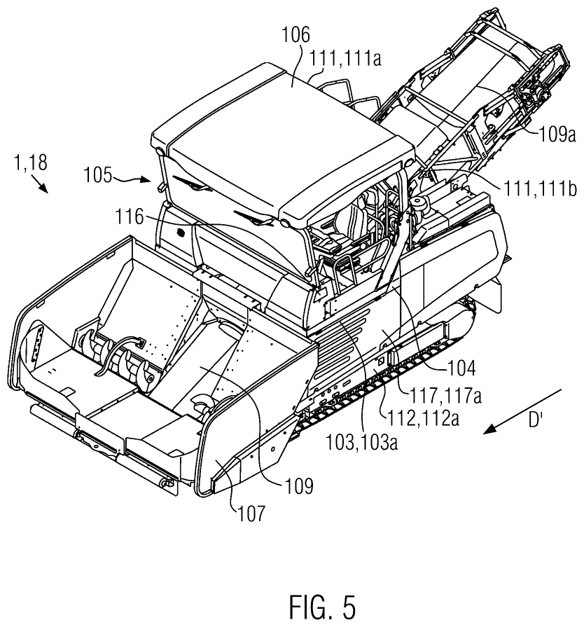

FIG. 5 shows a perspective view of a road construction machine 1, which is a feeder vehicle 18 for conveying paving material PM to a road paver 2 traveling behind it. The feeder vehicle 18 is self-propelled in a direction of travel D′.

The feeder vehicle 18 further comprises a chassis 104, a control stand 105, a driver's roof 106, a material hopper 107 with a material hopper insert 114 for receiving a paving material PM and a conveyor unit 109 comprising a conveyor belt 109a for transporting the paving material PM from the material hopper insert 114 of the feeder vehicle 18 into the material hopper insert 14 of the road paver 2.

The feeder vehicle 18 furthermore has two electrical consumers 111. A first electrical consumer 111a is a lighting device for illuminating the surroundings or the control stand 105. A second electrical consumer 111b is a heating device for heating the conveyor belt 109a.

A crawler chassis 112 is provided for moving the feeder vehicle 18. The crawler 112 has two driven crawlers 112a. The feeder vehicle 18 also has a primary drive 103 in the form of a combustion engine 103a to drive the crawler chassis 112. Compared to operation with an electric motor, the combustion engine 103a enables the feeder vehicle 18 to be operated relatively economically over a long range. This is particularly advantageous if there are no requirements for noise or pollutant limitations or if the feeder vehicle 18 is to be operated over long distances without interruption.

The combustion engine 103a is designed to drive the crawler chassis 112 in such a way that the crawler chassis 112 moves the feeder vehicle 18 in the direction of travel D′. To drive the crawler chassis 112, the combustion engine 103a and the crawler chassis 112 are mechanically connected to each other. The combustion engine 103a is also mechanically connected to a primary storage unit 117 and is supplied by this with an energy medium in the form of diesel fuel. For this purpose, the primary storage unit 117 is designed as a tank 117a for storing diesel fuel. The primary storage unit 117 is detachably mounted on the feeder vehicle 18 in the vicinity of the combustion engine 103a by means of a screw connection.

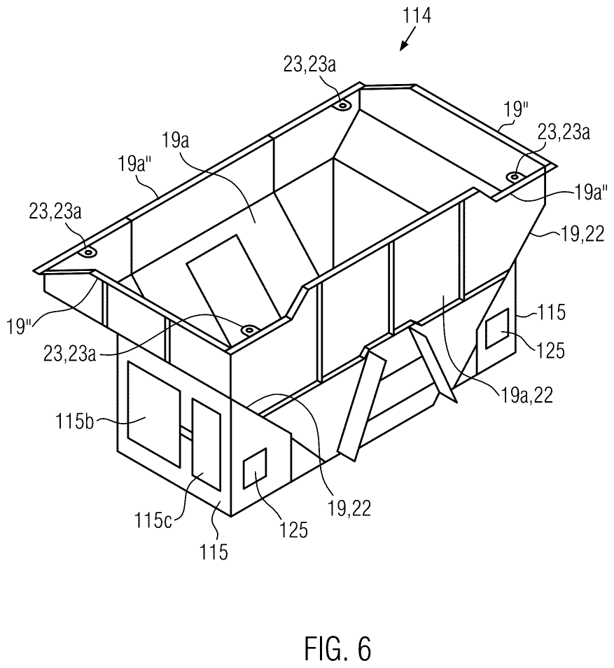

FIG. 6 shows details of the material hopper insert 114. The material hopper insert 114 of the feeder vehicle 18 has essentially the same structure as the material hopper insert 14 of the road paver 2. The elements of the material hopper insert 114 that correspond to those of the material hopper insert 14 are marked with the same reference signs. Two secondary storage units 115 are mounted on the material hopper insert 114 as well as on the material hopper insert 14.

In contrast to the secondary storage units 15 of the road paver 2, the secondary storage units 115 of the feeder vehicle 18 each have an additional tank 115b for storing diesel fuel and a secondary drive 115c in the form of a combustion engine for driving the crawler chassis 112. For this purpose, the secondary drive 115c is mechanically connected to the crawler chassis 112 via the interface 125. Furthermore, the auxiliary tank 115b is mechanically connected to the secondary drive 115c in order to supply the secondary drive 115c with diesel.

The feeder vehicle 18 is controlled via a control system 116 (see FIG. 5). The control system 116, the crawler chassis 112, the primary drive 103, the primary storage unit 117, the secondary storage unit(s) 115, i.e., the secondary drives 115c and the auxiliary tanks 115b, and the consumers 111 are communicatively connected to each other.

The control system 116 monitors an energy demand of the feeder vehicle 18. Furthermore, the control system 116 monitors a fill level of the primary storage unit 117, i.e., the tank 117a, and the secondary storage units 115, i.e., the additional tanks 115b. If the control system 116 recognizes, for example, that the energy generated by the primary drive 103 is too low for the operation of the feeder vehicle 18, the control system 116 causes the crawler chassis 112 to be additionally driven via the two secondary drives 115c. This prevents the feeder vehicle 18 from having to be stopped before the paving layer PL is completed, thereby interrupting the paving process.

As one skilled in the art would understand, the above-mentioned battery management system, thermal management system, control system 16 or 116, as well an any other system, unit, controller, drive, sensor, detector, device, component, subsystem, arrangement, or the like described herein may individually, collectively, or in any combination comprise appropriate circuitry, such as one or more appropriately programmed processors (e.g., one or more microprocessors including central processing units (CPU)) and associated memory which may include stored operating system software and/or application software executable by the processor(s) for controlling operation thereof and/or for performing the particular algorithms represented by the various functions and/or operations described herein, including interaction and/or cooperation between any such battery management system, thermal management system, control system, system, unit, controller, drive, sensor, detector, device, component, subsystem, arrangement, or the like. One or more of such processors, as well as other circuitry and/or hardware, may be included in a single component (e.g., an ASIC (Application-Specific Integrated Circuit)), or several processors and various circuitry and/or hardware may be distributed among several separate components, whether individually packaged or assembled into a SoC (System-on-a-Chip).

What is claimed is:

1. A road construction machine comprising:
a chassis for moving the road construction machine;
a primary drive for driving the chassis;
a primary storage unit for supplying the primary drive with electrical energy or an energy medium;
a material hopper; and
a material hopper insert for receiving paving material, wherein the material hopper insert is detachably mounted on the material hopper, and wherein the material hopper insert comprises at least one secondary storage unit for driving the chassis and/or for supplying the primary drive with electrical energy or the energy medium.

2. The road construction machine according to claim 1, wherein the primary drive comprises an electric motor.

3. The road construction machine according to claim 2, wherein the primary drive further comprises a fuel cell or a combustion engine.

4. The road construction machine according to claim 1, wherein the secondary storage unit comprises an auxiliary battery for storing electrical energy for the primary drive.

5. The road construction machine according to claim 4, wherein the secondary storage unit further comprises a battery management system.

6. The road construction machine according to claim 1, wherein the energy medium comprises hydrogen and/or ammonia and/or fossil fuel and/or a synthetic fuel.

7. The road construction machine according to claim 1, wherein the secondary storage unit comprises an additional tank for storing liquid or gaseous energy medium for the primary drive.

8. The road construction machine according to claim 7, wherein the additional tank is designed for a pressurized hydrogen storage or a storage of chemically bound hydrogen.

9. The road construction machine according to claim 1, wherein the secondary storage unit comprises a secondary drive for driving the chassis.

10. The road construction machine according to claim 1, wherein the material hopper insert defines a bottom opening and comprises a plurality of side walls adjacent thereto,
wherein a side wall of the plurality of side walls is inclined with respect to the bottom opening such that an upper edge of the inclined side wall lies outside the bottom opening,
wherein the secondary storage unit is arranged below the inclined side wall.

11. The road construction machine according to claim 10, wherein an angle between the inclined side wall and the bottom opening is at least 100°.

12. The road construction machine according to claim 11, wherein the angle is at least 110° and/or at most 135°.

13. The road construction machine according to claim 10, wherein the inclined side wall forms a cover for the secondary storage unit.

14. The road construction machine according to claim 1, wherein the material hopper insert comprises a thermal insulation.

15. The road construction machine according to claim 1, wherein the secondary storage unit is connectable to the road construction machine via an interface for transmitting electrical energy or the energy medium.

16. The road construction machine according to claim 1, wherein the road construction machine is a road paver for producing a paving layer from the paving material or a feeder vehicle for supplying a road paver with the paving material.

17. A method for replacing a material hopper insert on a road construction machine, the method comprising:
releasing a first fastening device of a first material hopper insert from a material hopper of the road construction machine;
removing the first material hopper insert with a first secondary storage unit from the material hopper;
inserting a second material hopper insert with a second secondary storage unit into the material hopper; and
fastening the second material hopper insert to the material hopper by a second fastening device.

18. The method according to claim 17,
wherein before the first material hopper insert is removed from the material hopper, a connection between the first secondary storage unit and the road construction machine via a first interface is released and/or
wherein a connection between the second secondary storage unit and the road construction machine via a second interface is established after the second material hopper insert has been attached to the material hopper, wherein electrical energy or an energy medium is transmittable between the secondary storage unit and the road construction machine via the second interface.

19. A method for operating a road construction machine, the method comprising:
providing electrical energy or an energy medium via a primary storage unit of the road construction machine;
supplying a primary drive of the road construction machine with the electrical energy or the energy medium via the primary storage unit;
driving a chassis of the road construction machine via the primary drive; and
moving the road construction machine via the chassis;
wherein a secondary storage unit supplies the primary drive with electrical energy or energy medium and/or wherein the secondary storage unit drives the chassis,
wherein the secondary storage unit is mounted on a material hopper insert for receiving paving material, and
wherein the material hopper insert is detachably mounted on a material hopper of the road construction machine.
